(19) United States
(12) Patent Application Publication
(10) Pub. No.: US 2025/0021614 A1
(43) Pub. Date: Jan. 16, 2025

(54) ASSISTANCE APPARATUS, ASSISTANCE METHOD, AND STORAGE MEDIUM

(71) Applicant: NEC Corporation, Minato-ku, Tokyo (JP)

(72) Inventor: Dai KUBOTA, Tokyo (JP)

(73) Assignee: NEC Corporation, Minato-ku, Tokyo (JP)

(21) Appl. No.: 18/711,334

(22) PCT Filed: Nov. 25, 2021
(86) PCT No.: PCT/JP2021/043192

§ 371 Date: May 17, 2024

(51) Int. Cl. G06F 17/11

(52) U.S. Cl. CPC G06F 17/11

(57) ABSTRACT

In order to enable facilitation of mathematical optimization, an assistance apparatus (1) includes: a reception section (11) which receives input of input data indicative of a problem to be solved as an optimization problem; and a modeling section (12) which determines or generates, in accordance with the input data, at least one of (i) a problem class used when the problem is handled as a mathematical optimization problem, (ii) an optimization model expressing the problem in the form of a mathematical optimization problem, and (iii) an optimization calculation algorithm for solving an optimization problem.

### TECHNICAL FIELD

The present invention relates to a technology for assisting mathematical optimization.

### BACKGROUND ART

In recent years, a technique called mathematical optimization is increasingly used in various fields. Mathematical optimization is a technique of expressing, in the form of a mathematical model, a problem for which a solution is to be found, and solving the mathematical model by optimization calculation to thereby derive a solution for the problem. Mathematical optimization is described, for example, in Non-Patent Literature 1 below.

### CITATION LIST

### Non-Patent Literature

[Non-patent Literature 1]
H. Paul Williams, “Model Building in Mathematical Programming”, John Wiley & Sons, 2013, P. 3-10.

### SUMMARY OF INVENTION

### Technical Problem

Mathematical optimization is a technique applicable to and effective in a wide variety of fields but cannot be said to be widely used at present. One of the reasons for that is a difficulty in application of mathematical optimization. For example, when performing mathematical optimization, it is necessary to determine a specific method of mathematical optimization, such as selecting a problem class in accordance with the problem to be solved, creating an optimization model suitable for the problem class, and selecting an optimization algorithm for solving the optimization model. However, in order to carry out the selection and the creation appropriately, it is necessary to have sufficient knowledge of mathematical optimization as well as sufficient understanding of the problem to be solved. Thus, the hurdles are too high for a person to apply mathematical optimization, if the person does not have enough of such knowledge and understanding.

An example aspect of the present invention has an object of providing an assistance apparatus and the like which enable facilitation of mathematical optimization.

### Solution to Problem

An assistance apparatus for assisting mathematical optimization in accordance with an example aspect of the present invention includes: a reception means for receiving input of input data indicative of a problem to be solved as an optimization problem; and a modeling means for determining or generating, in accordance with the input data, at least one of (i) a problem class used when the problem is handled as a mathematical optimization problem, (ii) an optimization model expressing the problem in the form of a mathematical optimization problem, and (iii) an optimization calculation algorithm for solving an optimization problem.

An assistance method in accordance with an example aspect of the present invention includes: receiving, by at least one processor, input of input data indicative of a problem to be solved as an optimization problem; and determining or generating, by the at least one processor and in accordance with the input data, at least one of (i) a problem class used when the problem is handled as a mathematical optimization problem, (ii) an optimization model expressing the problem in the form of a mathematical optimization problem, and (iii) an optimization calculation algorithm for solving an optimization problem.

An assistance program in accordance with an example aspect of the present invention causes a computer to function as: a reception means for receiving input of input data indicative of a problem to be solved as an optimization problem; and a modeling means for determining or generating, in accordance with the input data, at least one of (i) a problem class used when the problem is handled as a mathematical optimization problem, (ii) an optimization model expressing the problem in the form of a mathematical optimization problem, and (iii) an optimization calculation algorithm for solving an optimization problem.

### Advantageous Effects of Invention

An example aspect of the present invention makes it possible to provide an assistance apparatus and the like which enable facilitation of mathematical optimization.

### BRIEF DESCRIPTION OF DRAWINGS

FIG. 1 is a block diagram illustrating a configuration of an assistance apparatus in accordance with a first example embodiment of the present invention.

FIG. 2 is a flowchart illustrating a flow of an assistance method in accordance with the first example embodiment of the present invention.

FIG. 3 is a block diagram illustrating a configuration of an assistance apparatus in accordance with a second example embodiment of the present invention.

FIG. 4 is a diagram illustrating an example setting of a constraint in the second example embodiment of the present invention.

FIG. 5 is a diagram illustrating a method of approximating a quadratic function in the second example embodiment of the present invention.

FIG. 6 is a flowchart illustrating an example of a process related to error detection in the second example embodiment of the present invention.

FIG. 7 is a flowchart illustrating an example of a process related to optimization calculation in the second example embodiment of the present invention.

FIG. 8 is a diagram illustrating an example of a hardware configuration of an assistance apparatus in accordance with each of the example embodiments of the present invention.

### EXAMPLE EMBODIMENTS

### First Example Embodiment

The following description will discuss a first example embodiment of the present invention in detail with reference to the drawings. The present example embodiment is a basic form of an example embodiment described later.

### (Configuration of Assistance Apparatus 1)

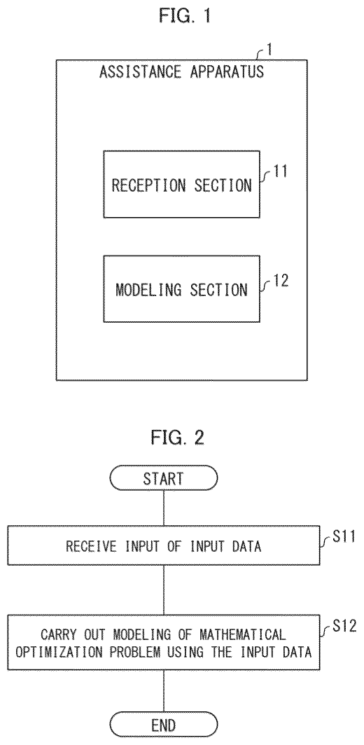

A configuration of an assistance apparatus 1 in accordance with the present example embodiment will be described with reference to FIG. 1. FIG. 1 is a block diagram illustrating a configuration of the assistance apparatus 1. As illustrated in FIG. 1, the assistance apparatus 1 includes a reception section 11 and a modeling section 12.

The reception section 11 receives input of input data indicative of a problem to be solved as an optimization problem. The modeling section 12 carries out modeling of a mathematical optimization problem with use of the input data.

Specifically, the modeling section 12 determines or generates, in accordance with the input data, at least one of (i) a problem class used when the problem indicated by the input data is handled as a mathematical optimization problem, (ii) an optimization model expressing the problem in the form of a mathematical optimization problem, and (iii) an optimization calculation algorithm for solving an optimization problem.

Thus, the assistance apparatus 1 in accordance with the present example embodiment is configured to include: the reception section 11 which receives input of input data indicative of a problem to be solved as an optimization problem; and the modeling section 12 which determines or generates, in accordance with the input data, at least one of (i) a problem class used when the problem is handled as a mathematical optimization problem, (ii) an optimization model expressing the problem in the form of a mathematical optimization problem, and (iii) an optimization calculation algorithm for solving an optimization problem.

According to the configuration, when input data indicative of a problem to which mathematical optimization is to be applied is inputted, at least one of a problem class, an optimization model, and an optimization calculation algorithm is automatically determined, each in accordance with the input data. Thus, the assistance apparatus 1 in accordance with the present example embodiment can provide an example advantage of enabling facilitation of mathematical optimization.

### (Assistance Program)

The above functions of the assistance apparatus 1 can be implemented via a program. An assistance program in accordance with the present example embodiment is configured to cause a computer to function as: a reception means for receiving input of input data indicative of a problem to be solved as an optimization problem; and a modeling means for determining or generating, in accordance with the input data, at least one of (i) a problem class used when the problem is handled as a mathematical optimization problem, (ii) an optimization model expressing the problem in the form of a mathematical optimization problem, and (iii) an optimization calculation algorithm for solving an optimization problem. Thus, the assistance program in accordance with the present example embodiment can provide an example advantage of enabling facilitation of mathematical optimization.

### (Flow of Assistance Method)

The following description will discuss a flow of an assistance method in accordance with the present example embodiment, with reference to FIG. 2. FIG. 2 is a flowchart illustrating a flow of the assistance method. Note that steps of the assistance method may be carried out by a processor of the assistance apparatus 1 or by a processor of another apparatus. Alternatively, the steps may be carried out by processors provided in respective different apparatuses.

In S11, at least one processor receives input of input data indicative of a problem to be solved as an optimization problem.

In S12, at least one processor carries out modeling of a mathematical optimization problem. Specifically, the at least one processor determines or generates, in accordance with the input data inputted in S11, at least one of (i) a problem class used when the problem is handled as a mathematical optimization problem, (ii) an optimization model expressing the problem in the form of a mathematical optimization problem, and (iii) an optimization calculation algorithm for solving an optimization problem.

Thus, the assistance method in accordance with the present example embodiment is configured to include: receiving, by at least one processor, input of input data indicative of a problem to be solved as an optimization problem; and determining or generating, in accordance with the input data and by the at least one processor, at least one of (i) a problem class used when the problem is handled as a mathematical optimization problem, (ii) an optimization model expressing the problem in the form of a mathematical optimization problem, and (iii) an optimization calculation algorithm for solving an optimization problem. Thus, the assistance method in accordance with the present example embodiment can provide an example advantage of enabling facilitation of mathematical optimization.

### Second Example Embodiment

### (Configuration of Assistance Apparatus 2)

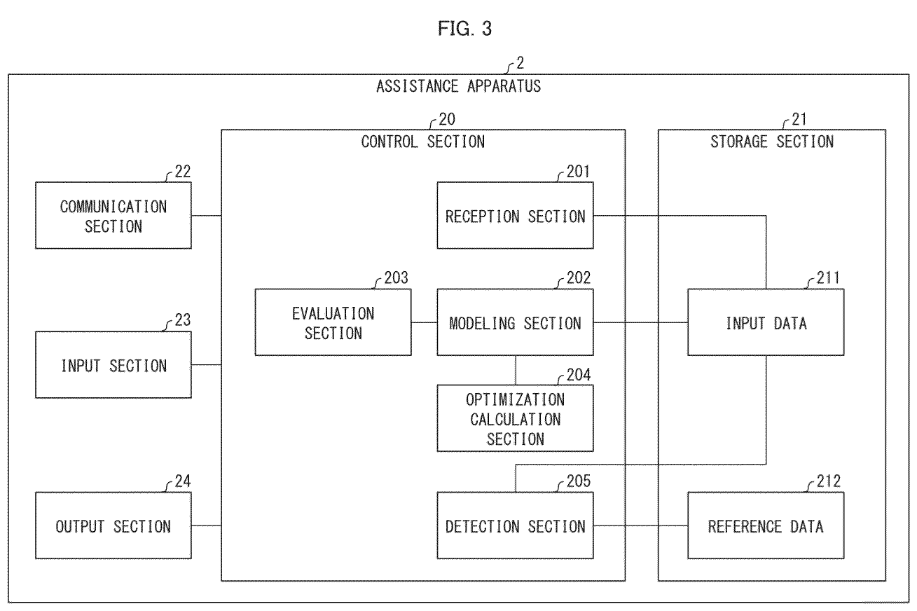

A configuration of an assistance apparatus 2 in accordance with the present example embodiment will be described with reference to FIG. 3. FIG. 3 is a block diagram illustrating a configuration of the assistance apparatus 2. As illustrated in FIG. 3, the assistance apparatus 2 includes a control section 20 which collectively controls sections of the assistance apparatus 2 and a storage section 21 in which various data used by the assistance apparatus 2 are stored. Further, the assistance apparatus 2 includes: a communication section 22 which allows the assistance apparatus 2 to communicate with other apparatuses; an input section 23 which receives input of various data to the assistance apparatus 2; and an output section 24 which allows the assistance apparatus 2 to output various data.

The control section 20 includes a reception section 201, a modeling section 202, an evaluation section 203, an optimization calculation section 204, and a detection section 205. In the storage section 21, input data 211 and reference data 212 are stored. Note that the reference data 212 will be described later in the section “Error detection using reference data”.

The input data 211 is data indicative of a problem to be solved as an optimization problem. For example, the input data 211 can include an objective function and a constraint which are formulated with respect to the problem to be solved. For example, in a case where the problem is a so-called shift scheduling problem, an objective function that indicates a degree to which the schedule suits (or does not suit) scheduling conditions (the required number of members, compatibility between members, preferences of each member, and the like) can be inputted as the input data 211. Further, a constraint indicative of an inhibited working pattern or the like can be included in the input data 211.

The reception section 201 receives input of the above-described input data 211 indicative of a problem to be solved as an optimization problem. The input data 211 can be inputted via the input section 23 or can be inputted from other apparatuses via the communication section 22.

The modeling section 202 carries out modeling of a mathematical optimization problem with use of the input data 211. Specifically, the modeling section 202 determines or generates, in accordance with the input data 211, at least one of (1) a problem class used when the problem indicated by the input data 211 is handled as a mathematical optimization problem, (2) an optimization model expressing the problem in the form of a mathematical optimization problem, and (3) an optimization calculation algorithm for solving an optimization problem. Note that the above process (1) to (3) can be carried out by respective different process blocks.

In general, when modeling of a mathematical optimization problem is carried out, first, a problem class to be applied to the problem to be solved is determined, and an optimization calculation algorithm for solving a mathematical optimization problem of the problem class is determined. Then, the problem to be solved is applied to the problem class and formulated into a form that is solvable by the optimization calculation algorithm. Thus, an optimization model is generated. These processes called modeling or formulation are operations which conventionally are manually performed and require specialized knowledge, so that the hurdles for carrying out the operations is high. The modeling section 202 automates at least part of the operations to thereby enable facilitation of mathematical optimization.

The evaluation section 203 makes an evaluation of each of a plurality of candidates for an optimization model, which are generated by the modeling section 202, in terms of suitability for the problem indicated by the input data 211. Further, the evaluation section 203 makes an evaluation of each of a plurality of candidates for an optimization calculation algorithm, which are determined by the modeling section 202, in terms of suitability for the problem indicated by the input data 211. Note that the evaluation section 203 can be configured to make an evaluation of only either the candidates for an optimization model or the candidates for an optimization calculation algorithm. Further, the evaluation of the candidates for an optimization model and the evaluation of the candidates for an optimization calculation algorithm can be made by respective different process blocks. Details of a method of evaluation will be described later.

Note here that although any optimization model that is suitable for a problem class is applicable to optimization calculation, the optimization calculation may take an enormous amount of time depending on the combination of the optimization model and the problem to which the optimization model is applied. Further, suitability related to memory, such as memory usage during optimization calculation, may matter.

The evaluation section 203 is useful as a means for solving such a problem. That is, the modeling section 202 generates a plurality of optimization models different from each other, and the evaluation section 203 makes an evaluation of the optimization models in terms of suitability for the problem indicated by the input data 211. Then, the modeling section 202 determines an optimization model to be applied, on the basis of a result of the evaluation made by the evaluation section 203 with respect to each of the plurality of optimization models which have been generated. Thus, it is possible to determine a highly reasonable optimization model.

Similarly, the evaluation section 203 can make an evaluation of candidates for an optimization calculation algorithm in terms of suitability for the problem indicated by the input data 211, and the modeling section 202 can determine, on the basis of a result of the evaluation of each of the plurality of optimization calculation algorithms, an optimization calculation algorithm to be applied. Thus, it is possible to determine a reasonable optimization calculation algorithm.

The optimization calculation section 204 carries out optimization calculation of a mathematical optimization problem modeled by the modeling section 202 and calculates an optimal solution. For example, it is assumed that the modeling section 202 generates an optimization model from the input data 211 and determines an optimization calculation algorithm for solving an optimization problem using the optimization model. In this case, the optimization calculation section 204 calculates an optimal solution by solving the optimization model generated with use of the optimization calculation algorithm.

### (Error Detection)

The detection section 205 detects an error in an expression included in the input data 211. The error detection can be carried out by, for example, a method in which a plurality of expressions included in the input data 211 are compared with each other.

In this case, the error detection section 205 compares the plurality of expressions included in the input data 211 with each other and determines whether or not there is a contradictory expression. For example, in a case where the input data 211 includes an expression “x>a” and an expression “x≤a”, the detection section 205 determines that there is a contradictory expression.

In a case where the detection section 205 determines that there is a contradictory expression, the detection section 205 determines which one of the plurality of expressions included in the input data 211 is contradictory and outputs a determination result. For example, in the example described above, the detection section 205 outputs a determination result indicative of “x>a” and “x≤a” (for example, indices allocated to these expressions in advance).

### (Error Detection Using Reference Data)

Further, in a case where the reference data 212 is stored in the storage section 21, the detection section 205 may detect an error in an expression included in the input data 211 by comparing the reference data 212 and the expressions included in the input data 211. Specifically, the detection section 205 obtains the input data 211 and the reference data 212 and determines whether or not the input data 211 and the reference data 212 thus obtained are contradictory to each other. Then, in a case where the detection section 205 determines that the input data 211 and the reference data 212 are contradictory to each other, the detection section 205 determines which one of the plurality of expressions included in the input data 211 is contradictory to the reference data 212, and outputs a determination result.

The reference data 212 is data to be compared with the input data 211, and is data known to be correct or highly likely to be correct with respect to the problem indicated by the input data 211. For example, various data (hereinafter referred to as past data) collected in past cases for a problem for optimization can be used as the reference data 212. This is because such past data can be interpreted as being a feasible solution satisfying a constraint to be taken into consideration.

The following will describe an example of error detection with use of past data as the reference data 212. An optimization problem indicated by (1) below is a problem of finding, with respect to an objective function f(x), an optimal solution Xₒₚₜ of an optimization variable x that satisfies the condition x∈X. In this problem, an optimization variable x that was actually applied in the past can be used as the reference data 212.

$$\begin{matrix}{x}_{opt} = {arg min}_{x} f ( x ) & s . t . x ∈ X\end{matrix} \qquad ( 1 )$$

For example, a problem of deriving a decision making that is optimal in light of a decision making in the past and a result of the decision making in the past can also be represented as (1) above. In this case, the result of the decision making in the past is represented as xᵢ (i=1, . . . , N). xᵢ (i=1, . . . , N) can be considered to be a reasonable solution of the above problem and can therefore be used as the reference data 212.

For example, the following considers a case of solving a problem of finding optimal seven-day work schedules of four persons A to D on the basis of past work data. In this problem, there is a constraint that, on each working day, one of person A or person B, who are employees, necessarily is to work. Binary variables indicative of whether or not A to D are to work on an n-th day are respectively represented as X_{A,n} to X_{D,n}. The objective function can be set in accordance with a preference for the work schedule (for example, persons who work on the same day get along well with each other, etc.).

The above constraint in the above problem can be represented as “x_{A,n}+x_{B,n}=1 for n=1, . . . , 7”. Further, work schedules on seven days in past work data, i.e., past data, are represented as x=(x_{A,1}, x_{B,1}, x_{C,1}, x_{D,1}, . . . , x_{A,7}, x_{B,7}, x_{C,7}, x_{D,7}), and these values are considered to satisfy the constraint. That is, (x_{A,1}+x_{B,1}) to (x_{A,7}+x_{B,7}) are each 1.

It is assumed here that the input data 211 includes a conditional expression “x_{A,n}+x_{B,n}=2 for n=1, . . . , 7”. In this case, the detection section 205 substitutes the past data x into the conditional expression. As indicated above, the past data x satisfies the constraint (x_{A,n}+x_{B,n}=1). Therefore, x_{A,n}+x_{B,n}≠2, and the conditional expression is therefore not satisfied. Through this, the detection section 205 can detect the presence of an error in the conditional expression.

There is known a technique called inverse reinforcement learning, in which past data as described above in a case where an appropriate decision was made is used as training data to learn criteria for judgement made when finding a solution of a problem for optimization. The training data used in this inverse reinforcement learning can be also used as the reference data 212.

Further, the objective function included in the input data 211 can be generated by inverse reinforcement learning. That is, by using, as the reference data 212, training data which has been used to generate the objective function included in the input data 211, it is possible to detect an error in the input data. Of course, training data used in a learning method other than inverse reinforcement learning can be also used as the reference data 212.

Note that the detection section 205 can be configured to carry out one of: a process of comparing a plurality of expressions included in the input data 211 with each other; and a process of comparing the reference data 212 with expressions included in the input data 211. Further, the process of comparing a plurality of expressions included in the input data 211 with each other; and a process of comparing the reference data 212 with expressions included in the input data 211 may be carried out by respective different process blocks.

As described above, the assistance apparatus 2 includes a detection section 205 which detects an error in an expression included in the input data 211, by carrying out at least one of: comparison of a plurality of expressions included in the input data 211 with each other; and comparison of a plurality of expressions included in the input data 211 with predetermined reference data 212. According to this configuration, in a case where an erroneous expression is included among a plurality of expressions included in the input data 211, the erroneous expression can be automatically detected.

Further, according to the configuration, by detecting the presence of an error as described above and determining which expression contains the error, it is also possible to correct (debug) the expression.

### (Determination of Problem Class and Optimization Calculation Algorithm)

As described above, the modeling section 202 is capable of determining a problem class used when a problem to be solved as an optimization problem is handled as a mathematical optimization problem. Further, the modeling section 202 is capable of determining an optimization calculation algorithm used when an optimization problem is solved. The problem class and the optimization calculation algorithm are determined in accordance with the input data 211. The method for determining the problem class and the optimization calculation algorithm is not particularly limited, and can be, for example, any of the following three methods.

### (1) Using Rule Base

A rule base indicative of a correspondence between the input data 211 and a problem class to be applied is provided in advance. The modeling section 202 can use the rule base to determine a problem class and an optimization calculation algorithm in accordance with the input data 211.

For example, the rule base can have registered therein a rule that indicates that a problem class to be applied in a case where all of the variables included in the input data 211 are binary variables 0 and 1 is a linear programming problem and a quadratic programming problem. It is possible to register, in the rule base, a rule that reflects know-how used when modeling is carried out manually, and this makes it possible to automatically make a decision similar to manual modeling.

Further, the rule can indicate that an optimization calculation algorithm suitable for a linear programming problem is an integer programming solver and a Boolean satisfiability testing solver. Further, the rule can indicate that an optimization calculation algorithm suitable for a quadratic programming problem is simulated annealing and quantum annealing. The association of the problem class and the optimization calculation algorithm can also reflect know-how used during manual modeling.

In using the rule as described above, the modeling section 202 determines whether or not all of the variables included in the input data 211 are binary variables, and in a case where all of the variables are binary variables, the modeling section 202 can specify that problem class candidates are a linear programming problem and a quadratic programming problem. Then, the modeling section 202 specifies that candidates for an optimization calculation algorithm corresponding to a linear programming problem are an integer programming problem solver and a Boolean satisfiability problem solver. Further, the modeling section 202 specifies that candidates for an optimization calculation algorithm corresponding to a quadratic programming problem are simulated annealing and quantum annealing.

As detailed later, the evaluation section 203 makes an evaluation of the candidates for a problem class which have been determined by the modeling section 202 and the candidates for an optimization calculation algorithm which have been determined by the modeling section 202. Then, the modeling section 202 determines a single problem class and a single optimization calculation algorithm on the basis of a result of the evaluation. Of course, it is possible to use a rule base that can determine a single problem class and a single optimization calculation algorithm without undergoing evaluation.

Further, the modeling section 202 does not necessarily need to determine both a problem class and an optimization calculation algorithm. That is, the modeling section 202 can determine an optimization calculation algorithm in a case where a problem class is designated, and can determine a problem class in a case where an optimization calculation algorithm is designated.

In the example described above, when a problem class is determined, an optimization calculation algorithm is determined in accordance with the problem class. Alternatively, the modeling section 202 can first determine an optimization calculation algorithm and then determine a problem class in accordance with the optimization calculation algorithm. In this case, the modeling section 202 can determine an optimization calculation algorithm such that, similarly to the case where a rule base is used, the modeling section 202 determines one or more optimization calculation algorithms in accordance with the problem class, or such that the modeling section 202 determines an optimization calculation algorithm with use of a learned model.

The objective variable of a learned model for determining an optimization calculation algorithm can be data (e.g., identification information of an optimization calculation algorithm) indicative of an optimization calculation algorithm, and the explanatory variable of the learned model can be the input data 211 or a feature extracted from the input data 211. Further, the explanatory variable can include other elements pertaining to modeling, such as a problem class to be applied.

### (2) Using Learned Model

A problem class and an optimization calculation algorithm can also be determined with use of a learned model that is constructed by machine learning of a relationship between the input data 211 and a problem class to be applied. In this case, the modeling section 202 can determine a problem class in accordance with the input data 211, with use of the learned model.

The objective variable of a learned model for determining a problem class can be data (e.g., identification information of a problem class) indicative of a problem class, and the explanatory variable of the learned model can be the input data 211 or a feature extracted from the input data 211. Examples of the feature value include a type of an optimization problem, a type of a variable contained, the number of variables, and a degree of a mathematical expression. Further, the explanatory variable can include information indicative of other elements pertaining to modeling, such as an optimization calculation algorithm to be applied.

For example, the modeling section 202 can use a learned model constructed by machine learning of a relationship between (i) an objective variable that is data indicating that a problem class is a linear programming problem and a quadratic programming problem and (ii) an explanatory variable that is: input data in which all of the variables included are binary variables; or a feature value indicating that all of the variables included in the input data are binary variables.

When input data in which all of the variables included are binary variables or a feature value indicating that all of the variables included in the input data 211 are binary variables is inputted to such a learned model, a value indicative of that the problem class to be applied is a linear programming problem and a quadratic programming problem is output. Thus, the modeling section 202 can determine a problem class to be applied, on the basis of an output value obtained by inputting, to the learned model, the input data 211 or a feature value extracted from the input data 211.

### (3) Using Reinforcement Learning Model

A problem class can also be determined with use of a reinforcement learning model for determining a problem class in accordance with the input data 211. The reinforcement learning model can be constructed, for example, by carrying out learning with use of: a “state” which is input data or a feature extracted from the input data; an “action” which is a problem class to be applied in the state; and a “reward” which is a result of evaluation of suitability of the action.

Data indicative of the “state” in reinforcement learning can be, for example, a feature extracted from input data (for example, data indicative of whether or not all variables included in the input data are binary variables).

The “reward” can be calculated such that the suitability is high if the applied problem class (action) is reasonable and is low if the applied problem class (action) is not reasonable. For calculation of the “reward”, it is also possible to use a suitability index such as calculation time and memory usage required for calculation (the less calculation time and memory usage, the higher the suitability). This makes it possible to determine a problem class in which less calculation time and memory usage are required.

The reinforcement learning can be carried out, for example, with use of a benchmark problem prepared in advance, such as a shift scheduling problem in which only binary variables appear. Such reinforcement learning makes it possible to determine an action in which a reward to be acquired is maximized, i.e., an optimal problem class.

### (Evaluation of Problem Class and Optimization Calculation Algorithm)

As described above, the modeling section 202 can determine a plurality of different candidates for a problem class and a plurality of different candidates for an optimization calculation algorithm. In this case, the evaluation section 203 can make an evaluation of each candidate in terms of suitability for a problem to be solved as an optimization problem. In this case, the modeling section 202 can determine, on the basis of a result of the evaluation made by the evaluation section 203 with respect to each candidate, a problem class and an optimization calculation algorithm which are to be applied.

Examples of an index for the evaluation include calculation speed and memory usage required for calculation. For example, the evaluation section 203 can calculate, from the number of constraints and the number of variables included in the optimization problem, an index value indicative of calculation speed or an index value indicative of memory usage.

Further, the problem classes and the optimization calculation algorithms that are candidates can be actually subjected to optimization calculation, and a calculation speed and memory usage during the optimization calculation can be measured. In this case, formulation (generation of an optimization model) can be carried out by the modeling section 202 or by a user. Further, the problem to be solved by optimization calculation can be a problem indicated in the input data 211 or can be a problem for evaluation of an optimization calculation algorithm such as a benchmark problem.

Note that the evaluation section 203 does not need to make an evaluation of both (i) candidates for a problem class and (ii) candidates for an optimization calculation algorithm. The evaluation section 203 can make an evaluation of candidates for an optimization calculation algorithm in a case where a problem class is designated by a user, and the evaluation section 203 can make an evaluation of candidates for a problem class in a case where an optimization calculation algorithm is designated by a user.

### (Generation of Optimization Model)

As described above, the modeling section 202 can also generate an optimization model which expresses, in the form of a mathematical optimization problem, the problem indicated by the input data 211. The generation of the optimization model can be reworded as “formulation of a mathematical optimization problem”, and the optimization model can be reworded as a collection of formulated mathematical expressions. The formulation is carried out so as to suit a problem class designated by a user or the like or determined by the modeling section 202.

For example, the modeling section 202 can generate an optimization model formulated in a form suitable for a problem class to be applied, by converting expressions included in the input data 211 in accordance with a predetermined conversion rule. This makes it possible to generate an optimization model formulated in a form suitable for a problem class to be applied. Further, as described later, it is also possible to generate an optimization model based on know-how of formulation, by using the know-how as a conversion rule.

The above conversion rule can be one that converts each of the expressions (e.g., a conditional expression expressed in the form of a logical formula or a mathematical expression expressed in the form of an equality or inequality) included in the input data 211 into one or more expressions that are suitable for the problem class to be applied.

It is preferable that the modeling section 202 output, without excess or deficiency, a mathematical expression that is a model representation in a designated problem class, from a conditional expression expressed by a logical formula or a mathematical expression expressed by an equality or an inequality in the input data 211. In other words, it is preferable that the modeling section 202 generate an optimization model that is without deficiencies such as part of the conditions indicated by the input data 211 is missing in the optimization model. It is also preferable that the modeling section 202 generate an optimization model in a form that can be inputted, as it is or through a simple conversion, to an optimization calculation algorithm designated by a user or the like or determined by the modeling section 202.

The method of generating an optimization model is not particularly limited, and the optimization model can be generated, for example, by any of the methods (1) to (3) below.

### (1) Using Rule Base

By preparing, in advance, a rule base indicative of a correspondence between the input data 211 and a conversion rule to be applied, it is possible for the modeling section 202 to determine a conversion rule in accordance with the input data 211 with use of the rule base. Then, the modeling section 202 can generate an optimization model by converting the input data 211 in accordance with the determined conversion rule.

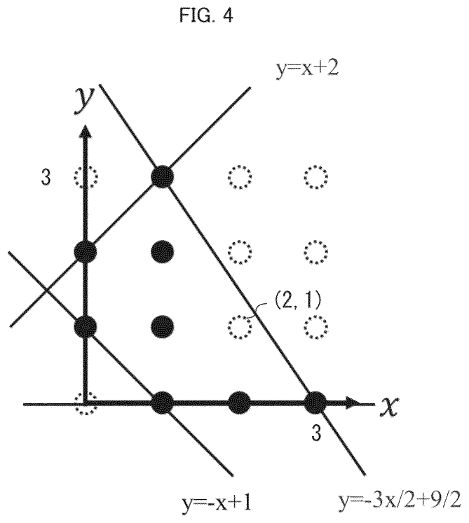

For example, it is assumed that a user wants to set, for x and y which are each an integer variable, a constraint having a feasible region illustrated in FIG. 4. FIG. 4 is a diagram illustrating an example setting of a constraint. In FIG. 4, a set of feasible x and y is plotted on the xy plane. There are eight of such plots. Note that the broken circles represent an infeasible region.

In this case, the user can include variable definitions 0≤x≤3 and 0≤y≤3 in the input data 211 and also include a logical formula representing a constraint, such as the formula below, in the input data 211. Note that the logical formula may include, for example, an operator such as max and min.

$$( ¬ ( x = 0 ⋀ y = 0 ) ) ⋀ ¬ ( x = 0 ⋀ y = 3 ) ) ⋀ ( y = 0 if x \geq 2 )$$

Such a logical formula can be relatively easily prepared even by a user unfamiliar with modeling of optimization calculation. Note, however, that the above logical formula does not consist only of a linear equality/inequality. As such, there are cases where it is not possible for the logical expression to be used as it is for optimization calculation.

For such input data 211 containing a logical formula indicative of feasible and impossible regions, a rule can be registered in the rule base which rule indicates that an algorithm for finding a convex hull containing all of the feasible solutions is applied to the input data 211. In the example illustrated in FIG. 4, the modeling section 202 finds straight lines (the x-axis, the y-axis, y=x+2, y=−x+1, and y=−3x/2+9/2) that surround the eight plots representing the feasible region, and thus obtains an inequality below. Note that any algorithm for finding a convex hull can be applied.

$$0 \leq x \leq 3 , 0 \leq y \leq 3 , 1 \leq x + y , y - x \leq 2 , 3 x + 2 y \leq 9$$

Note that within these ranges, a broken circle (2, 1) which indicates an infeasible region is included, as illustrated in FIG. 4. Overlooking this point can result in significant errors in optimization calculation. Therefore, the rule can further include a rule that indicates that in a case where a region that cannot be represented in a convex region is included, in other words, in a case where an infeasible region is included in a convex region, a dummy variable for eliminating the infeasible region is introduced.

In this case, the modeling section 202 introduces a dummy variable z in accordance with the above rule. Specifically, in the above-described input data 211, it is only y=0 that satisfies the constraint within the range of x≥2. As such, the modeling section 202 introduces a logical value z∈{0, 1} for determining whether or not x≥2. In order that x≤1 when z=0 and x>2 when z=1, the modeling section 202 generates inequalities x−1≤az and bz≥x (where a≥2 and b≥1) and selects a single set of a and b (a=2, b=1) to obtain an inequality x−1≤2z≤x.

Further, in order that y=0 is always satisfied when z=1, the modeling section 202 can set c(1−z)≥y in addition to the variable definition 0≤y≤3. At this time, the modeling section 202 sets c≥3 in order to prevent giving a wrong constraint to y when z=0. For example, the modeling section 202 can set c=3. In this case, inequalities below are ultimately generated. All of these are linear inequalities, and can be used for optimization calculation as they are.

$$0 \leq x \leq 3 , 0 \leq y \leq 3 , 1 \leq x + y , y - x \leq 2 , 3 x + 2 y \leq 9 , x - 1 \leq 2 z \leq x , 3 ( 1 - z ) \geq y$$

### (2) Using Learned Model

The conversion rule can also be determined using a learned model constructed by machine learning of a relationship between the input data 211 and a conversion rule to be applied. In this case, the modeling section 202 can use the learned model to determine a problem class in accordance with the input data 211 and convert the input data 211 in accordance with the determined conversion rule to generate an optimization model.

Such a learned model can be constructed in a similar manner to the learned model used for determination of a problem class and an optimization calculation algorithm. For example, the modeling section 202 can use a learned model that is constructed with use of (i) an objective variable which is data indicative of a conversion rule (for example, identification information of a conversion rule) and (ii) an explanatory variable which is the input data 211 or a feature extracted from the input data 211. Further, the explanatory variable can include information indicative of other elements pertaining to modeling, such as an optimization calculation algorithm or a problem class to be applied.

Further, the modeling section 202 can generate a plurality of candidates for a conversion rule applicable to the conversion of the input data 211 and determine a single conversion rule to be applied, on the basis of a result of evaluation made by the evaluation section 203 for each of the generated candidates. The plurality of candidates can be generated using a rule base as described above or can be generated using a learned model as described above.

The above evaluation can also be carried out by applying a learned model constructed by machine learning. An objective variable of the learned model can be data that serves as an index for evaluating a generation rule, and an explanatory variable of the learned model can be the input data 211 or a feature extracted from the input data 211. Further, the explanatory variable can include information indicative of other elements pertaining to modeling, such as an optimization calculation algorithm to be applied.

For example, the evaluation section 203 can carry out, with respect to each of the conversion rules that are candidates, an evaluation with use of a prediction model that predicts the number of variables and the number of constraints which will be there when the conversion rule is applied. Such a prediction model can be constructed by machine learning using training data generated on the basis of a result of converting a benchmark problem in accordance with each conversion rule. In a case where such an evaluation is carried out, the modeling section 202 can, for example, determine a single conversion rule by a method such as applying, from among the candidates for a conversion rule, a candidate having a smallest sum of the number of variables and the number of constraints.

Note that the index for the evaluation can be any index that determines suitability of the conversion rule, and is not limited to the number of variables and the number of constraints. For example, a calculation speed, a memory usage required for calculation, and the like can be used as indices for the evaluation.

The following will describe a specific example of determining a single conversion rule from candidates for a conversion rule. It is assumed here that the following constraint is to be expressed: in reservation of a meeting room by two people, namely, person A and person B, person A and person B cannot make a reservation of a meeting room on the same day of the week. Note that person A and person B each make a reservation of a meeting room up to once a week (neither person A nor person B makes a reservation of a meeting room twice or more a week). In this case, it is conceivable that the user, for example, generates input data 211 such as “x_{A,n}=x_{B,n}=0 if x_{A,n}=x_{B,n}” with use of binary variables x_{A,n}, x_{B,n} (n=1, . . . , 7) which represent reservations on an n-th day of the week.

In this case, it is assumed that the modeling section 202 generates (A) and (B) below as candidates for an optimization model.
(A) A constraint which is 1≥x_{A,n}+x_{B,n} (i.e., an inequality that excludes x_{A,n}=x_{B,n}=1).
(B) Two integer variables x_{A}∈{0, 1, . . . , 7} and x_{B}∈{1, . . . , 7, 8} are used to express a reservation status. Note that 1≤x*≤7 represents a status where a reservation corresponding to the number is made, and the other cases (i.e., x_{A}=0 and x_{B}=8) each represent a status where not a single reservation is made. Further, z is a binary variable which is 1 when x_{A}>x_{B} and which is 0 in other times. At this time, the constraint can be expressed as (B−1) below, and an expression (B−2) can be obtained from the expression (B−1). Note that M can be any constant having a high value and satisfying M≥9.

$$\vert {x}_{A} - {x}_{B} \vert \geq 1 \qquad ( B - 1 )$$

$${x}_{A} - {x}_{B} \geq 1 - M ( 1 - z ) , {x}_{A} {x}_{B} \leq - 1 + Mz \qquad ( B - 2 )$$

In this case, a prediction model for predicting the number of variables and the number of constraints is learned in advance from a benchmark problem or the like with respect to the two optimization models (A) and (B). This allows the evaluation section 203 to evaluate the optimization models with use of the prediction model. Then, the modeling section 202 can determine an optimization model to be applied, on the basis of a result of the evaluation.

### (3) Using Reinforcement Learning Model

Further, the conversion rule can be determined with use of a reinforcement learning model for determining a conversion rule in accordance with the input data 211. The reinforcement learning model can be constructed, for example, by carrying out learning with use of: a “state” which is input data or a feature extracted from the input data; an “action” which is a conversion rule to be applied in the state; and a “reward” which is a result of evaluation of suitability of the action.

The index for the evaluation of suitability only needs to be one that serves as an index for determining suitability of the conversion rule. For example, calculation speed, memory usage in calculation, and the like as well as the number of variables and the number of constraints described above can be used as indices for the evaluation.

### (Approximation)

In a case where an optimization model suitable for a certain problem class is generated from an expression indicated in the input data 211, an approximate representation may be required, since conversion from a given problem class to another problem class may not necessarily be equivalent. In such a case, the modeling section 202 can receive input of a control parameter related to a degree of accuracy in approximation and carry out approximation in accordance with the control parameter to generate an optimization model.

For example, it is assumed that, in a case where an objective function included in the input data 211 includes a term x², either a linear programming problem is designated as a problem class or the modeling section 202 decides to handle a problem class as a linear programming problem. In this case, since it is not possible for a quadratic expression to be accurately expressed only with use of a linear expression, it is necessary to carry out approximation.

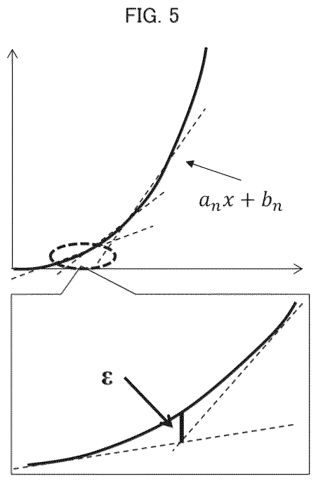

Approximation will be described with reference to FIG. 5. FIG. 5 is a diagram illustrating a method of approximating a quadratic function. As illustrated in FIG. 5, a quadratic function such as x² can be approximated with use of a tangent (aₙx+bₙ) of the quadratic function (n=1, . . . ). Further, since only a linear term can be used in a linear programming problem, x² in the objective function is expressed with use of a new variable y. In this case, giving y≥aₙx+bₙ as a constraint enables approximate representation of x² included in the objective function.

In this case, a maximum error ε between x² and the tangent is, as illustrated in FIG. 5, a distance between x² and the tangent at a position furthest from the point of tangency. As apparent from FIG. 5, the maximum error ε decreases as the number of tangents increases. Thus, for example, in a case where the maximum error ε is designated as a control parameter by a user operation via the input section 23 or the like, the modeling section 202 can adjust the number of tangents (a range of n) such that the distance between x² and a tangent does not exceed the designated maximum error ε.

As described above, in a case where the modeling section 202 receives designation of a degree of accuracy in approximation, the modeling section 202 can generate an optimization model by converting a mathematical expression included in the input data 211 by approximation that satisfies the designated degree of accuracy. This makes it possible to generate an optimization model with a degree of accuracy desired by a user.

### (Process Flow: Error Detection)

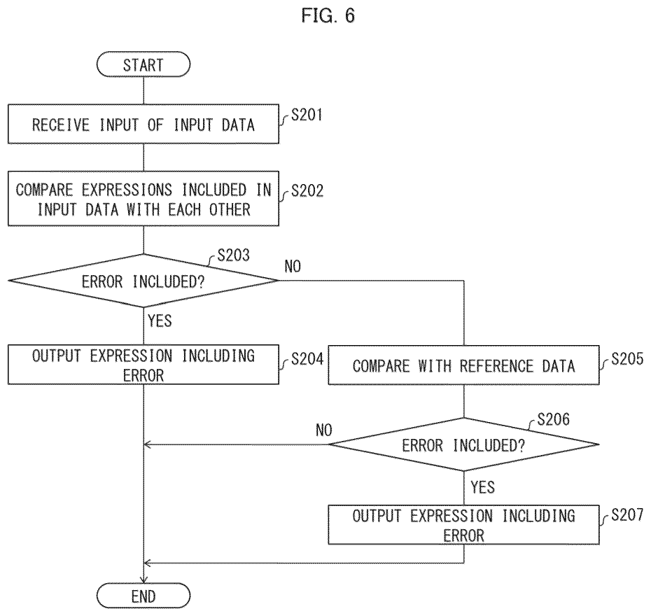

The following will describe, with reference to FIG. 6, a flow of a process related to error detection. FIG. 6 is a flowchart illustrating an example of a process related to error detection.

In S201, the reception section 201 receives input of input data 211. In the subsequent S202, the detection section 205 compares expressions included in the input data 211 with each other (S202). Then, the detection section 205 determines whether or not the compared expressions include an error (S203). In a case where it is determined in S203 that an erroneous expression is included (YES in S203), the process proceeds to S204, and in a case where it is determined at S203 that no erroneous expression is included (NO in 203), the process proceeds to S205.

In S204, the detection section 205 outputs the erroneous expression detected by the comparison in S202. Thus, the process illustrated in FIG. 6 is ended. Note that the process can be configured such that the error in the outputted expression is corrected (debugged), and then the input data 211 in which the expression with the error has been corrected can be subjected to S202 and the subsequent processes.

In S205, the detection section 205 compares the reference data 212 with the expressions included in the input data 211. Then, in S206, the detection section 205 determines whether or not the input data 211 includes an erroneous expression.

In a case where it is determined in S206 that an erroneous expression is included (YES in S206), the process proceeds to S207. In S207, the detection section 205 outputs the erroneous expression detected by the comparison in S205, and ends the process illustrated in FIG. 6. Note that the process can be configured such that the error in the outputted expression is corrected (debugged), and then the input data 211 in which the expression with the error has been corrected can be subjected to S202 and the subsequent processes.

In a case where it is determined in S206 that no erroneous expression is included (NO in S206), the process illustrated in FIG. 6 is ended. Note that although two types of comparison, namely S202 and S205, are carried out in the example illustrated in FIG. 6, the process can be configured such that only one of the two types of comparison is carried out.

As described above, the assistance apparatus 2 includes: the reception section 201 which receives input of input data 211 indicative of a problem to be solved as an optimization problem, and the detection section 205 which detects an error in an expression included in the input data 211, by carrying out at least one of (1) comparison of a plurality of expressions included in the input data 211 with each other and (2) comparison of a plurality of expressions included in the input data 211 with the reference data 212. Thus, in a case where an erroneous expression is included among a plurality of expressions included in the input data 211, the erroneous expression can be automatically detected.

### (Process Flow: Optimization Operation)

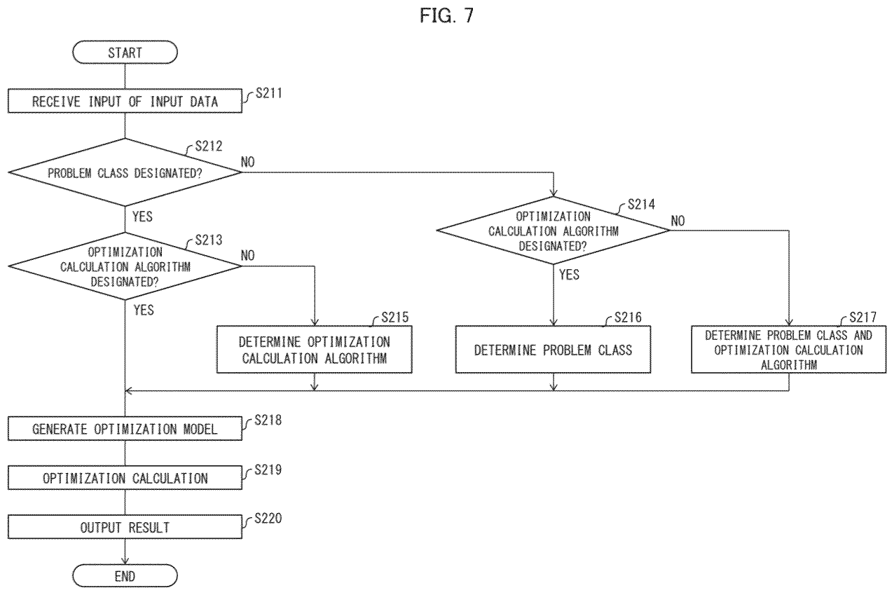

The following will describe, with reference to FIG. 7, a flow of a process related to optimization calculation. FIG. 7 is a flowchart illustrating an example of a process related to optimization calculation. Note that although the example illustrated in FIG. 7 does not describe error detection by the detection section 205, it is needless to say that error detection as illustrated in FIG. 6 can be carried out before S212 after S211.

In S211, the reception section 201 receives input of input data 211. In S211, the reception section 201 can receive designation of either or both of a problem class and an optimization calculation algorithm in addition to the input data 211.

In S212, the modeling section 202 determines whether or not a problem class is designated. In a case where a problem class is designated (YES in S212), the process proceeds to S213, and in a case where no problem class is designated (NO in S212), the process proceeds to S214.

In S213, the modeling section 202 determines whether or not an optimization calculation algorithm is designated. In a case where an optimization calculation algorithm is designated (YES in S213), the process proceeds to S218, and in a case where no optimization calculation algorithm is designated (NO in S213), the process proceeds to S215.

In S214, the modeling section 202 determines whether or not an optimization calculation algorithm is designated. In a case where an optimization calculation algorithm is designated (YES in S214), the process proceeds to S216, and in a case where no optimization calculation algorithm is designated (NO in S214), the process proceeds to S217.

In a case where the process proceeds to S217, that is, in a case where neither a problem class nor an optimization calculation algorithm is designated, the modeling section 202 determines a problem class and an optimization calculation algorithm in accordance with the input data 211 inputted in S211. At this time, the modeling section 202 can determine a plurality of candidates for a problem class and a plurality of candidates for an optimization calculation algorithm. In this case, the evaluation section 203 carries out an evaluation of each of the candidates, and the modeling section 202 can determine a single problem class and a single optimization calculation algorithm on the basis of a result of the evaluation.

In a case where the process proceeds to S216, that is, in a case where no problem class is designated and an optimization calculation algorithm is designated, the modeling section 202 determines a problem class in accordance with the input data 211 inputted in S211, the problem class being suitable for the designated optimization calculation algorithm. At this time, the modeling section 202 can first determine a plurality of candidates for a problem class, and the evaluation section 203 can make an evaluation of each of the candidates. Then, the modeling section 202 can determine a single problem class on the basis of a result of the evaluation.

In a case where the process proceeds to S215, that is, in a case where a problem class is designated and no optimization calculation algorithm is designated, the modeling section 202 determines an optimization calculation algorithm in accordance with the input data 211 inputted in S211, the optimization calculation algorithm being suitable for the designated problem class. At this time, the modeling section 202 can first determine a plurality of candidates for an optimization calculation algorithm, and the evaluation section 203 can make an evaluation of each of the candidates. Then, the modeling section 202 can determine a single optimization calculation algorithm on the basis of a result of the evaluation. For example, by making an evaluation based on whether or not the calculation efficiency is good, it is possible to determine an optimization calculation algorithm with high calculation efficiency in the designated problem class.

In S218, the modeling section 202 generates an optimization model which expresses, in the form of a mathematical optimization problem, the problem indicated by the input data 211 in S211. At this time, the modeling section 202 can first determine a plurality of candidates for an optimization model, and the evaluation section 203 can make an evaluation of each of the candidates. Then, the modeling section 202 can determine a single optimization model on the basis of a result of the evaluation.

In S219, the optimization calculation section 204 carries out optimization calculation with use of the optimization model generated in S218, to thereby calculate an optimal solution. The optimization calculation algorithm used in this optimization calculation is either designated or determined in S215 or S217. Further, the problem class of the optimization calculation is either designated or determined in S216 or S217.

In S220, the optimization calculation section 204 causes the output section 24 to output a calculation result calculated in S219. Thus, the process illustrated in FIG. 7 is ended. Note that the calculation result can be outputted to any destination in S220, and can be outputted to, for example, a display apparatus external to the assistance apparatus 2 etc. Further, S220 can be omitted, and the calculation result can be stored in the storage section 21 or the like. Further, the optimization calculation in S219 can be carried out, for example, by an apparatus other than the assistance apparatus 2, such as another information processing apparatus suitable for calculation with use of the generated optimization model.

Note that in S215 to S217, the modeling section 202 does not necessarily need to determine a single optimization calculation algorithm and a single problem class, and can proceed to S218 as of when a plurality of candidates for an optimization calculation algorithm and a plurality of candidates for a problem class are determined. In this case, in S218, the modeling section 202 can generate optimization models corresponding to the respective candidates, and determine, on the basis of a result of evaluation made by the evaluation section 203 with respect to those optimization models, an ultimate single final optimization calculation algorithm and an ultimate single problem class.

Further, when narrowing a plurality of candidates down to an ultimately applied single one, an intention of a user can be reflected. For example, with respect to at least one of an optimization calculation algorithm, a problem class, and an optimization model, the modeling section 202 can present generated or determined candidates to the user, for example, by causing the output section 24 to output the candidates. Then, the modeling section 202 can determine to apply, among the presented candidates, for example, one which is designated by a user operation via the input section 23. At this time, the modeling section 202 can also present a result of evaluation made by the evaluation section 203 with respect to each of the candidates, so that the result serves as a reference for determination by the user.

Note that FIG. 7 illustrates an example in which the modeling section 202 can determine or generate all of the modeling elements of: an optimization calculation algorithm; a problem class; and an optimization model. Note, however, that the modeling section 202 is only required to be configured such that the modeling section 202 determines or generates at least one of the above-described elements. Elements that cannot be determined or generated by the modeling section 202 can be designated by a user.

### [Variations]

In the example embodiment described above, an example in which the input data 211 is a logical formula, an equality, or an inequality has been shown. Note, however, that the input data 211 only need be indicative of a problem to be solved as an optimization problem, and is not limited to this example. For example, the input data 211 can be a representation, in the form of text rather than a mathematical expression, of problem to be solved as an optimization problem. In this case, the assistance apparatus 2 can include an expression forming means for forming an expression of an optimization problem from the text. This makes it possible to carry out modeling of optimization calculation with use of an objective function and a constraint generated by the expression forming means, through a process similar to that of the above-described example embodiment. Similarly, the input data 211 can be, for example, a diagram, a table (graph), and the like, or text indicative of a problem can be audio-inputted.

The processes described in the example embodiments above may be carried out by any entity, not confined to the above-described examples. That is, an assistance system having functions similar to those of each of the assistance apparatuses 1 and 2 can be constructed by a plurality of apparatuses that can communicate with each other. For example, an assistance system having functions similar to those of each of the assistance apparatuses 1 and 2 can be constructed by dispersedly providing, in a plurality of apparatuses, blocks illustrated in each of FIGS. 1 and 3.

### Reference Example

The assistance apparatus 2 can also be configured to include at least the reception section 201 and the detection section 205. That is, the configurations such as the modeling section 202 can be omitted. According to such an assistance apparatus 2, in a case where an erroneous expression is included among a plurality of expressions included in input data 211, the erroneous expression can be automatically detected. This enables assistance of modeling.

### [Software Implementation Example]

Some or all of functions of each of the assistance apparatuses 1 and 2 can be realized by hardware such as an integrated circuit (IC chip) or can be alternatively realized by software.

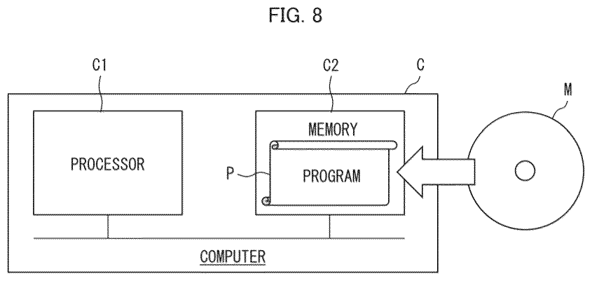

In the latter case, the assistance apparatus 1 and 2 are each realized by, for example, a computer that executes instructions of a program that is software realizing the functions. FIG. 8 illustrates an example of the computer (hereinafter referred to as “computer C”). The computer C includes at least one processor C1 and at least one memory C2. In the memory C2, a program P (assistance program) for causing the computer C to operate as the information processing apparatus 1 or 2 is stored. In the computer C, the functions of the state determination apparatus 1 or 1A are realized by the processor C1 reading the program P from the memory C2 and executing the program P.

The at least one processor C1 can be, for example, a central processing unit (CPU), a graphic processing unit (GPU), a digital signal processor (DSP), a micro processing unit (MPU), an floating point number processing unit (FPU), a physics processing unit (PPU), a microcontroller, or a combination thereof. The memory C2 can be, for example, a flash memory, a hard disk drive (HDD), a solid state drive (SSD), or a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can also be stored in a non-transitory tangible storage medium M from which the computer C can read the program P. Such a storage medium M can be, for example, a tape, a disk, a card, a semiconductor memory, a programmable logic circuit, or the like. The computer C can obtain the program P via such a storage medium M. The program P can also be transmitted via a transmission medium. The transmission medium can be, for example, a communications network, a broadcast wave, or the like. The computer C can obtain the program P also via such a transmission medium.

### [Additional Remark 1]

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following example aspects.

### (Supplementary Note 1)

An assistance apparatus for assisting mathematical optimization, including: a reception means for receiving input of input data indicative of a problem to be solved as an optimization problem; and a modeling means for determining or generating, in accordance with the input data, at least one of (i) a problem class used when the problem is handled as a mathematical optimization problem, (ii) an optimization model expressing the problem in the form of a mathematical optimization problem, and (iii) an optimization calculation algorithm for solving an optimization problem. This configuration can provide an example advantage of enabling facilitation of mathematical optimization.

### (Supplementary Note 2)

The assistance apparatus described in supplementary note 1, wherein the modeling means converts the input data in accordance with a predetermined conversion rule to thereby generate the optimization model formulated in a form suitable for a problem class to be applied. According to this configuration, it is possible to generate an optimization model formulated in a form suitable for a problem class to be applied.

### (Supplementary Note 3)

The assistance apparatus described in supplementary note 1 or 2, further including an evaluation means for making an evaluation of the optimization model in terms of suitability for the problem, the modeling means generating a plurality of optimization models from different each other and determining, on the basis of a result of the evaluation of each of the plurality of optimization models, an optimization model to be applied. According to this configuration, it is possible to determine a highly reasonable optimization model.

### (Supplementary Note 4)

The assistance apparatus described in any one of supplementary notes 1 to 3, further including an evaluation for making an evaluation of the optimization means calculation algorithm in terms of suitability for the problem, the modeling means determining, on the basis of a result of the evaluation of each of a plurality of optimization calculation algorithms, an optimization calculation algorithm to be applied. According to this configuration, it is possible to determine a highly reasonable optimization calculation algorithm.

### (Supplementary Note 5)

The assistance apparatus described in any one of supplementary notes 1 to 3, further including a detection means for detecting an error in an expression included in the input data, by carrying out at least one of: comparison of a plurality of expressions included in the input data with each other; and comparison of a plurality of expressions included in the input data with predetermined reference data. According to this configuration, in a case where an erroneous expression is included among a plurality of expressions included in the input data, the erroneous expression can be automatically detected. Further, according to the configuration, by detecting the presence of an error as described above and determining which expression contains the error, it is also possible to correct (debug) the expression.

### (Supplementary Note 6)

The assistance apparatus described in any one of supplementary notes 1 to 5, wherein in a case where the modeling means receives designation of a degree of accuracy in approximation, the modeling generates the optimization model by converting, by approximation satisfying the designated degree of accuracy, a mathematical expression included in the input data. According to this configuration, it is possible to generate an optimization model with a degree of accuracy desired by a user.

### (Supplementary Note 7)

An assistance method, including: receiving, by at least one processor, input of input data indicative of a problem to be solved as an optimization problem; and determining or generating, by the at least one processor and in accordance with the input data, at least one of (i) a problem class used when the problem is handled as a mathematical optimization problem, (ii) an optimization model expressing the problem in the form of a mathematical optimization problem, and (iii) an optimization calculation algorithm for solving an optimization problem. This assistance method makes it possible to obtain an effect similar to the effect of supplementary note 1.

### (Supplementary Note 8)

An assistance program for causing a computer to function as: a reception means for receiving input of input data indicative of a problem to be solved as an optimization problem; and a modeling means for determining or generating, in accordance with the input data, at least one of (i) a problem class used when the problem is handled as a mathematical optimization problem, (ii) an optimization model expressing the problem in the form of a mathematical optimization problem, and (iii) an optimization calculation algorithm for solving an optimization problem. This assistance program makes it possible to obtain an effect similar to the effect of supplementary note 1.

### [Additional Remark 3]

Furthermore, some of or all of the above example embodiments can also be expressed as below.

An information processing apparatus, including at least one processor, the at least one processor carrying out: a reception process of receiving input of input data indicative of a problem to be solved as an optimization problem; and a modeling process of determining or generating, in accordance with the input data, at least one of (i) a problem class used when the problem is handled as a mathematical optimization problem, (ii) an optimization model expressing the problem in the form of a mathematical optimization problem, and (iii) an optimization calculation algorithm for solving an optimization problem.

Note that the information processing apparatus can further include a memory. In the memory, an assistance program for causing the processor to carry out the reception process and the modeling process. The assistance program may be stored in a computer-readable non-transitory tangible storage medium.

### REFERENCE SIGNS LIST

1: Assistance apparatus
11: Reception section
12: Modeling section
2: Assistance apparatus
201: Reception section
202: Modeling section
203: Evaluation section
205: Detection section
211: Input data
212: Reference data

What is claimed is:

1. An assistance apparatus for assisting mathematical optimization, comprising at least one processor, the at least one processor carrying out:
a reception process of receiving input of input data indicative of a problem to be solved as an optimization problem; and
a modeling process of determining or generating, in accordance with the input data, at least one of (i) a problem class used when the problem is handled as a mathematical optimization problem, (ii) an optimization model expressing the problem in the form of a mathematical optimization problem, and (iii) an optimization calculation algorithm for solving an optimization problem.

2. The assistance apparatus according to claim 1, wherein in the modeling process, the at least one processor converts the input data in accordance with a predetermined conversion rule to thereby generate the optimization model formulated in a form suitable for a problem class to be applied.

3. The assistance apparatus according to claim 1, wherein the at least one processor further carries out an evaluation process of making an evaluation of the optimization model in terms of suitability for the problem, and
in the modeling process, the at least one processor generates a plurality of optimization models different from each other and determining, on the basis of a result of the evaluation of each of the plurality of optimization models, an optimization model to be applied.

4. The assistance apparatus according to claim 1, wherein the at least one processor further carries out an evaluation process of making an evaluation of the optimization calculation algorithm in terms of suitability for the problem, and
in the modeling process, the at least one processor determines, on the basis of a result of the evaluation of each of a plurality of optimization calculation algorithms, an optimization calculation algorithm to be applied.

5. The assistance apparatus according to claim 1, wherein the at least one processor further carries out a detection process of detecting an error in an expression included in the input data, by carrying out at least one of: comparison of a plurality of expressions included in the input data with each other; and comparison of a plurality of expressions included in the input data with predetermined reference data.

6. The assistance apparatus according to claim 1, wherein in the modeling process, in a case where the at least one processor receives designation of a degree of accuracy in approximation, the at least one processor generates the optimization model by converting, by approximation satisfying the designated degree of accuracy, a mathematical expression included in the input data.

7. An assistance method, comprising:
receiving, by at least one processor, input of input data indicative of a problem to be solved as an optimization problem; and
determining or generating, by the at least one processor and in accordance with the input data, at least one of (i) a problem class used when the problem is handled as a mathematical optimization problem, (ii) an optimization model expressing the problem in the form of a mathematical optimization problem, and (iii) an optimization calculation algorithm for solving an optimization problem.

8. A non-transitory storage medium storing therein an assistance program for causing a computer to carry out:
a reception process of receiving input of input data indicative of a problem to be solved as an optimization problem; and
a modeling process of determining or generating, in accordance with the input data, at least one of (i) a problem class used when the problem is handled as a mathematical optimization problem, (ii) an optimization model expressing the problem in the form of a mathematical optimization problem, and (iii) an optimization calculation algorithm for solving an optimization problem.
